(19) United States
(12) Patent Application Publication
(10) Pub. No.: US 2010/0053988 A1
(43) Pub. Date: Mar. 4, 2010

(54) Vehicle Projector Lamp

(76) Inventors: Michael A. Strazzanti, Gates Mills, OH (US); Richard H. Taylor, Willoughby, OH (US)

Correspondence Address: JEANNE E. LONGMUIR, 2836 CORYDON ROAD, CLEVELAND HEIGHTS, OH, 44118, US

(21) Appl. No.: 12/551,398

(22) Filed: Aug. 31, 2009

Related U.S. Application Data
(60) Provisional application No. 61/093,094, filed on Aug. 29, 2008.

(51) Int. Cl. B60Q 1/00; H01J 9/24

(52) U.S. Cl. 362/539; 362/538; 445/23

(57) ABSTRACT

A projector lamp for a vehicle headlamp and method for continuously forming the same, which lamp is formed from one piece of sheet metal and includes a cylindrical lens holder and a cup shaped reflector for reflecting light from a vehicle bulb toward the cylindrical lens holder. Integral tabs formed from and extending inwardly from the cylindrical lens holder secure an optical lens within the cylindrical lens holder.

### CROSS-REFERENCE TO RELATED APPLICATION

The present application claims priority from U.S. Patent Application Ser. No. 61/093,094, filed Aug. 29, 2008, the entire subject matter of which is incorporated herein by reference

### BACKGROUND OF THE INVENTION

The present invention relates to a vehicle lamp assembly, and more specific to a projection style lamp which is a component of a lamp assembly, but is a single material contiguous design to reduce weight and improve manufacturing efficiency.

Conventional projector style headlamps consist of multiple components which are assembled together by various means such as resistance welding, screws, fasteners and friction stir welding. The components include a light source, a concave reflector shell for reflecting the light source image, and an optic lens for redistributing the reflected light. In some instances the headlamp is required to have an additional flat plate located between light source and the optic lens to shade portions of the light output from exiting the reflector. Additionally, some form of bracket or other means is necessary to hold the optic lens in the proper location relative to the reflector and light source. One such assembly is described in U.S. Pat. No. 4,857,794.

The components of such a lamp assembly or projector lamp are comprised from various materials, including steel, aluminum, plastic and powdered metal. The manufacturing methods and assembly techniques vary widely and include die casting, metal stamping, injection molding, forging, riveting, welding and screwing.

### BRIEF SUMMARY OF THE INVENTION

The present application is for a vehicle projector lamp or lamp assembly which can be manufactured as one piece using a series of multiple forming operations or a line die operation, or, preferably, a progressive die capable of producing a single stamping which provides the structure of the projector lamp and a method for forming the lamp. The progressive die used to manufacture the lamp consists of multiple stations which sequentially form the lamp stamping which has multiple components of the conventional assembly integrated into a single contiguous component. The major features formed in the tool are a drawn cup for a reflector, a drawn or formed cylinder to hold the optic lens (lens holder), a shield or shade plate which provides a horizontal illumination cutoff line and various locking tabs and support features for final assembly.

In order to achieve the required reflectivity for optical performance the component may undergo a coating operation to improve the specular or spectral reflectivity of the interior surface of the reflector. The conventional methods of coating in this regard include a base coat which serves to smooth out the rough surface of the steel and provide improved specular reflectance. The area is then coated with a thin film of a material with high spectral reflectance such as Aluminum or Silver. Alternately, a material with high spectral reflectivity such as Aluminum can be used to form the component. In this instance the interior surface of the reflector may undergo manual or electrochemical polishing to improve specular reflectivity. One such commercial electrochemical process is known as Brytal electropolishing.

The lamp may also undergo swaging, staking or welding operations to fold the stamping up and secure the various regions together. These operations may take place in the progressive forming tool, or in a secondary operation.

### BRIEF DESCRIPTION OF THE DRAWINGS

FIG. 1 shows the top and side views of the sequence of events at multiple numbered stations for progressively forming the assembly from a single piece of metal;

FIG. 2 shows a view of the lamp assembly in the stage of forming when the spring tabs are formed in the lens holder to retain the optic lens;

FIG. 3 shows the front and side view of three lamp assemblies stacked in preparation for a secondary coating operation;

FIG. 4 shows a top, side and isometric view of the lamp assembly with the bulb holder and shade plate integrated;

FIG. 5 shows a top, side and isometric view of the lamp assembly with only the lens holder integrated, and not the bulb holder or shade plate;

FIG. 6 shows a top, side and isometric view of the lamp assembly with the lens holder and shade plate integrated, omitting the bulb holder;

FIG. 7 shows a cross sectional view of the lamp assembly in FIG. 4; and

FIG. 8 shows a cut away view of the lamp assembly having a lens held within the lamp assembly.

### DETAILED DESCRIPTION OF THE INVENTION

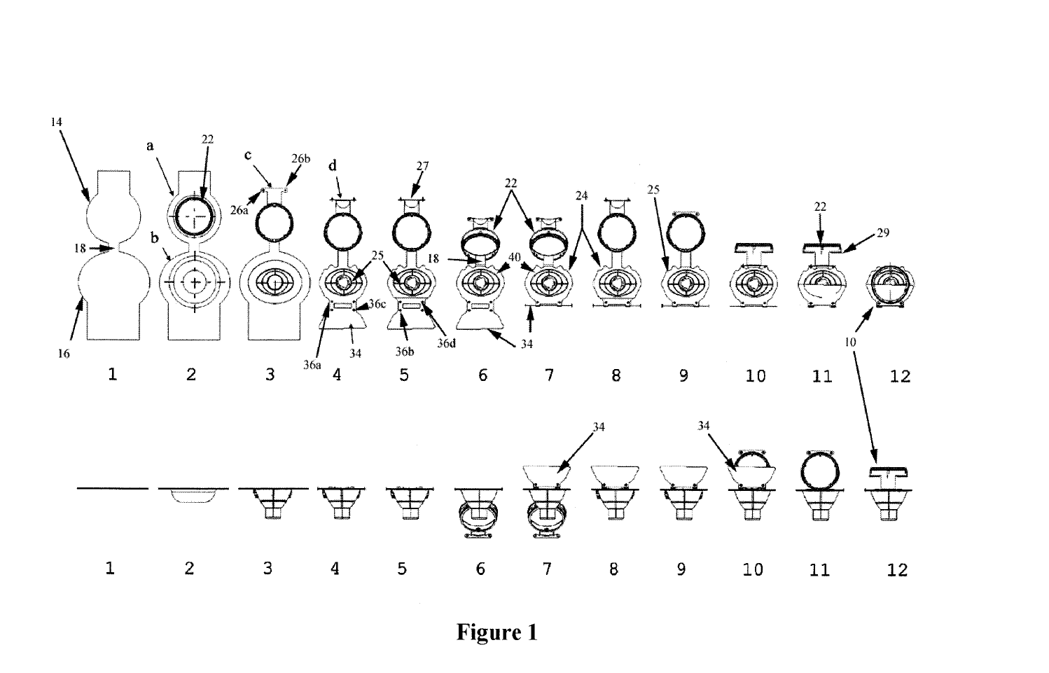

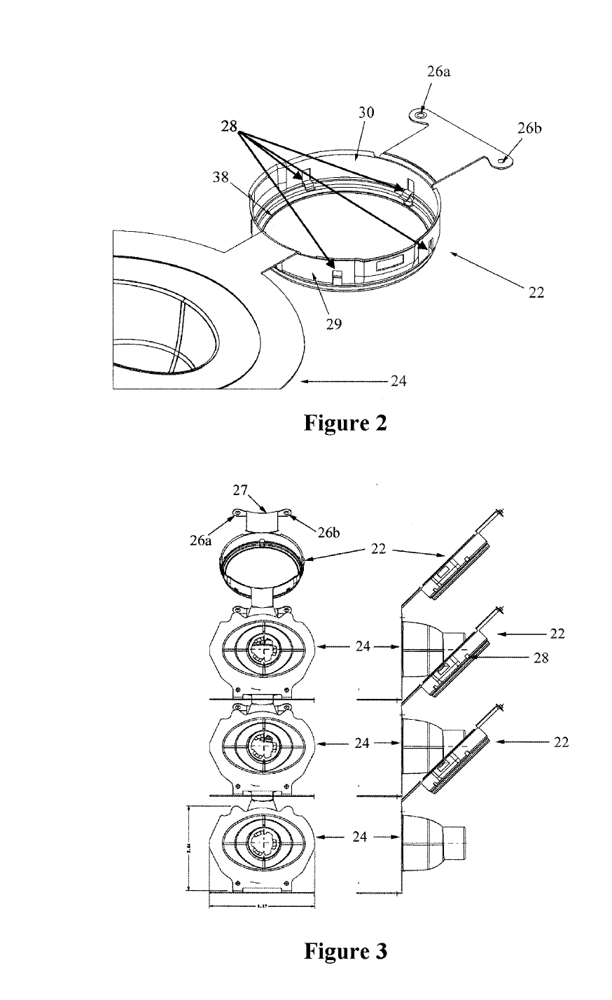

Projection style headlamps have gained prevalence in recent years due to their improved light output and distribution on a roadway setting. The conventional designs are comprised of multiple components (e.g. a reflector, a lens holder, a bulb holder and a shade plate). These components are formed separately from steel sheets, made as individual die castings or powdered metal. The components are then assembled in one or more assembly operations. In FIG. 1, a metal, such as steel, blank 12 is indicated in station 1. The blank 12 is comprised of two substantially circular regions with rectangular ends 14, 16 connected with a strip 18 as shown. Subsequent forming operations will result in the creation of a functional projector lamp 10 structure from this single blank 12. In the forming station labeled 2 in FIG. 1, a reflector 24 is drawn into the area marked (a) and the lens holder 22 is drawn into the area marked (b). In the third station, the area of the blank 12 marked (c) is trimmed, and 2 holes 26a, 26b are pierced and extruded downward. A hole having a central axis is cut in the bottom of the reflector 24 to allow bulb access. Area (c) will act as a connection point to the opposite side of the blank 16 once the lamp assembly 10 is fully formed. Four (4) tabs 28 are also formed in the wall 30 of the shell 29 which forms the lens holder 24. These tabs 28 are formed, for example, in a lancing operation so that the tabs extend inward towards the center of the shell wall 30 as shown in FIG. 2.

In the station marked 4, the opposite side of the blank 12 is trimmed to create the shield or shade plate 34. Four (4) holes 36a, 36b, 36c, 36d are also formed or pierced at this station 4, which holes will align with the 2 holes 26a, 26b formed at station 3 once the lamp assembly 10 is more fully formed. Additionally, station 4 includes a forming operation for the area marked (d), in which a portion 27 of the area containing holes 26a, 26b is bent downward 90 degrees, as best seen in FIG. 3. The flange area 40 of the reflector 24 is also trimmed to create mounting surfaces 42 for installation in a vehicle. In station 5, a hole 38 having a central axis is cut in the bottom of the shell 29 which forms the lens holder 24 to allow the convex surface C of the optical lens L to protrude from the cylindrical shell 29.

At this point the major features of the lamp 10 are formed and the lens holder 22 side of the blank 12 is bent downward at an angle, as in Stations 6 and 7. This operation is useful to allow the blanks 12 to be placed or supported on a rack for a subsequent metallization or electropolishing operation. The resulting orientation of 3 lamp assemblies 10 is shown in FIG. 3. This orientation maximizes the number of lamps 10 which can fit on a rack and improves the efficiency of such an operations. In the instance where the lamp 10 is not required to go through a secondary operation (e.g. manual polishing of high purity aluminum) this forming operation may be eliminated.

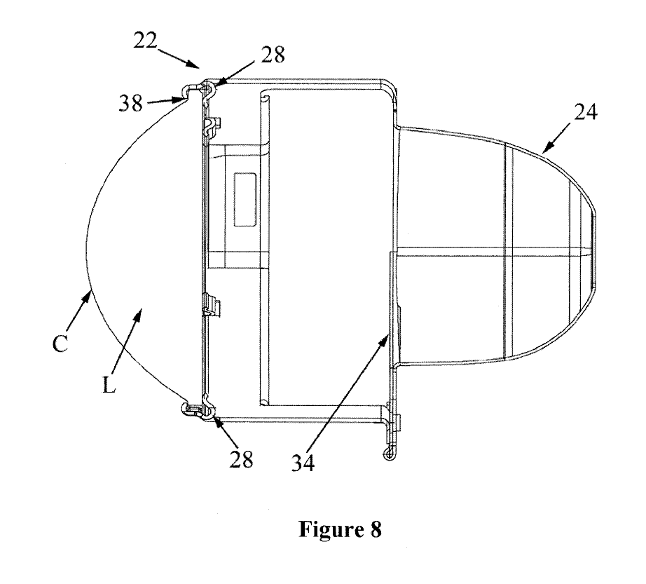

Once the interior surface 23 of the reflector 22 is properly prepared to meet reflectivity requirements, the lamp 10 is formed into its final configuration. One such forming sequence is shown in FIG. 1, at stations 7 through 12. In station 7, the shade plate 34 is folded upward to a 90 degree angle. In station 8, the lens holder 22 is folded back up into its original flat position. In station 9, the leg or bent portion 27 adjacent to the lens holder 22 is formed up 90 degrees. In station 10, the lens holder shell 29 is bent 90 degrees upward along the strip 18 connecting the lens holder 22 to the reflector 24. In station 11, the shade plate 34 is bent 90 degrees to lay flat against the reflector flange 25. In station 12, the lens holder 22 is bent at 90 degrees at the reflector 24 and the strip 18 connecting to the lens holder 22. At this point in the process a connection is made to interconnect the two holes 26a, 26b formed in station 3 with the four holes 36a, 36b, 36c, 36d formed in station 4, which are now aligned in a vertical stack. FIG. 7 shows a cross section of this area. The extrusions 49 can then be formed to secure the lamp 10 in position, and also with openings 45 to enable additional fastenings. Such additional securing elements such as threaded fasteners, rivets, friction stirring or electrical resistance spot welds may be used in addition to or in place of the extrusion connection method. The optic lens and bulb, as shown in FIG. 8, can be installed within the lamp 10 after assembly is completed or at some other point between stations 7 and 12.

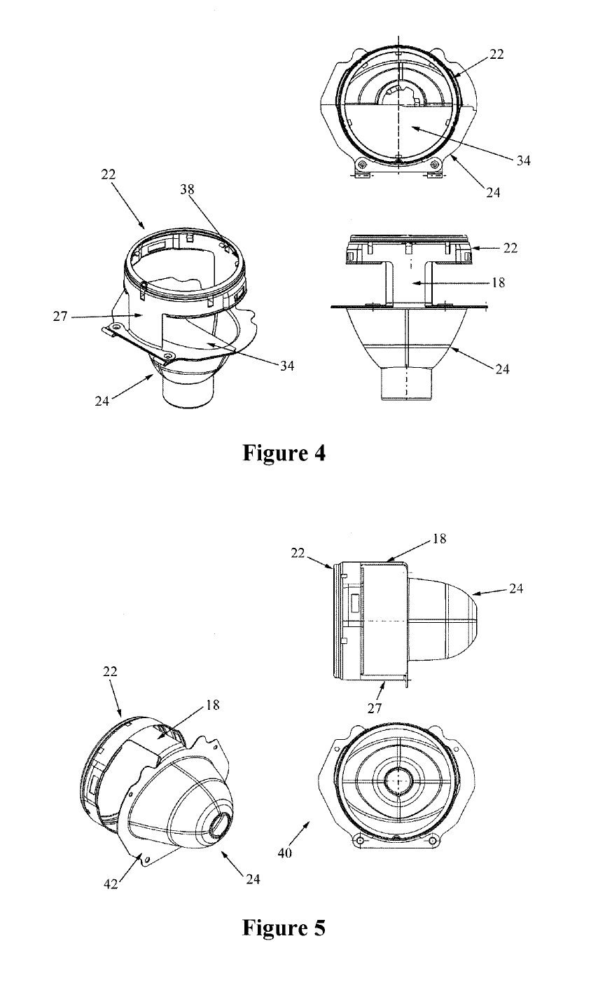

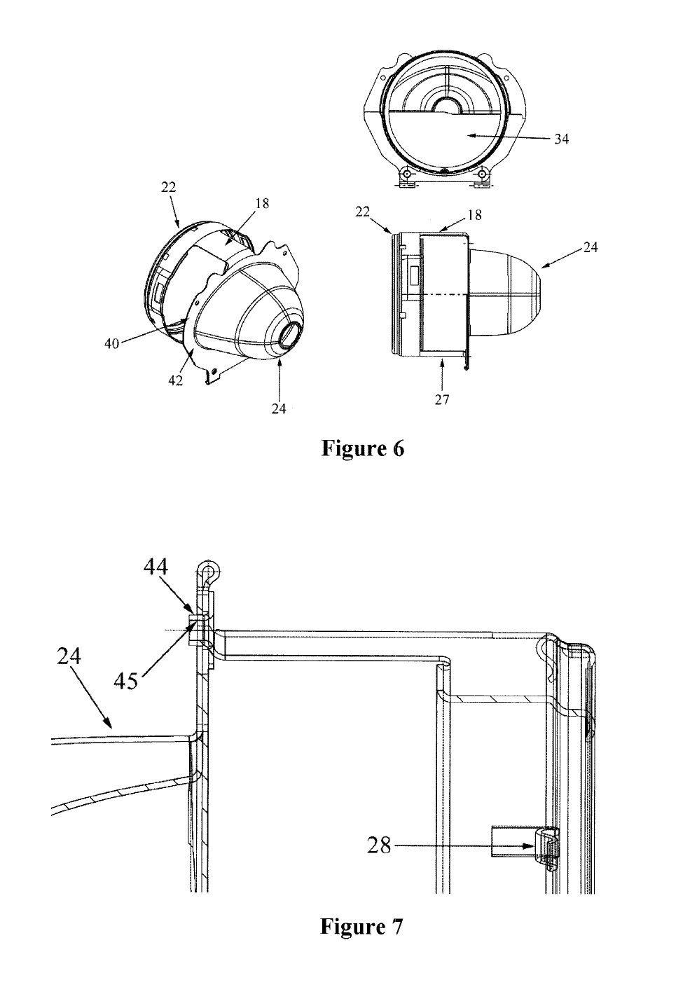

In the case of a projector lamp 10 made to produce a high beam or fog lamp beam pattern, the shade plate 34 in FIG. 1, may be omitted. Additionally, the diameter of any desired bulb holder may require the bottom of the reflector 24 to have an opening that makes the peripheral surface area insufficient to achieve photometric prescription requirements for the vehicle headlamp. This area is indicated as (a) in FIG. 4. Two alternatives are presented here to alleviate this situation. In the first instance the projector lamp assembly 10 may be produced without integrating the bulb holder or socket. This alternate part is shown in FIG. 5. Additionally, the projector lamp 10 may be formed for a low beam without a bulb socket but with the shade plate 34 as shown in FIG. 6.

An alternative solution to removing the bulb holder is to perform a necking operation in the area (a) of FIG. 4. This involves the tapering of the reflector down towards the bulb holder in a way that reduces the diameter of the opening formed by the draw of the bulb holder cylinder. U.S. Pat. No. 5,469,729 describes such a necking operation; however this or many other methods of reducing this diameter are known to those skilled in the art of metal forming and may be employed.

Alternately, the projector lamp 10 may be formed by deep drawing a single shell. The bottom of the shell functions as the reflector. Spring tabs are formed in a similar manner as described above along the top perimeter of the shell. A hole having a central axis is cut in the bottom of the cylinder to allow bulb installation and the rim of the shell is trimmed and formed to secure the optic lens against the spring tabs. Additionally a rectangular shaped piece is cut from the wall of the cylinder and bent downward at a 90 degree angle. This will form the required horizontal shield for the required low beam cutoff line, which enables proper photometric operation of the vehicle headlamp. Other areas of the side wall of the shell may be removed through piercing operations to prevent unwanted light reflection and reduce component weight.

The result of the manufacturing method described here is a final projector lamp 10 with one coating process, one assembly process and one stamping process/tool formed from one steel blank 12. Compared with the conventional systems with up to six separate stampings formed from six separate metal sheets, multiple assembly and coating processes, the present method and lamp design provides a novel and economically beneficial product and process, both in material usage, product weight, product assembly and reduced tooling costs.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A projector lamp for a vehicle headlamp which is formed from one piece of sheet metal.

2. The projector lamp of claim 1, wherein the projector lamp comprises a cylindrical lens holder and a cup shaped reflector for reflecting light from a vehicle bulb toward the cylindrical lens holder.

3. The projector lamp of claim 2 wherein the projector lamp further includes tabs formed from and extending inwardly from the cylindrical lens holder for securing an optical lens within the cylindrical lens holder.

4. A projector lamp for a vehicle headlamp comprising,
a cylindrical lens holder for holding an optical lens using integral tabs extending from the lens holder,
a reflective bulb holder for holding a vehicle lamp bulb and having an associated cup shaped reflector for directing light from a vehicle lamp bulb; and
an interconnecting strip between the cylindrical lens holder and the reflective bulb holder.

5. The projector lamp of claim 4, wherein the cylindrical lens holder, reflective bulb holder and interconnecting strip are an integral strip of metal.

6. The projector lamp of claim 5 wherein the reflective bulb holder further includes a shield plate for partially covering the cup shaped reflector.

7. A method for manufacturing a projector lamp comprising the steps of:
stamping a piece of sheet metal to form two substantially circular sections interconnected by a strip;
forming a cup shaped reflector with a central axis in one of the circular sections;
forming a substantially cylindrical lens holder with a central axis in the other one of the circular sections; and
bending the reflector and lens holder to form a projector lamp such that the central axes of the reflector and lens holder are in parallel.
